(19) United States
(12) Patent Application Publication
(10) Pub. No.: US 2002/0196398 A1
(43) Pub. Date: Dec. 26, 2002

(54) Opaque shielding element for liquid crystal display

(75) Inventors: David Paul Jones, Cardife (GB); Richard John Bullock, Newport (GB)

Correspondence Address: GEORGE O. SAILE, 20 MCINTOSH DRIVE, POUGHKEEPSIE, NY, 12603, US

(73) Assignee: European Semiconductor Manufacturing Limited

(21) Appl. No.: 09/898,385

(22) Filed: Jul. 5, 2001

(30) Foreign Application Priority Data
Jun. 21, 2001 (GB) 0115275.0

(51) Int. Cl. G02F 1/1333; G02F 1/13

(52) U.S. Cl. 349/122

(57) ABSTRACT

LCDs for use in high intensity applications such as digital projectors are susceptible to performance degradation resulting from unwanted photoconductive effects that result from scattered light. Furthermore, the constraints under which these devices operate require that their TFTs be made of polysilicon. The present inventions shows how these problems can be overcome by inserting an opaque optical shielding element between the TFT active layer and the lower transparent plate of the LCD. Materials suitable for use in the shielding layer include thermally deposited silicon nitride, layers of silicon oxide and silicon nitride, and a refractory metal encapsulated in a suitable barrier layer. By making the lower transparent plate and the shielding element from refractory materials, the TFT active layer can be made of polysilicon (as opposed to amorphous silicon) since the plate and shield element will not be affected by the high temperatures, in excess of 1,000 EC, to which they will be exposed when the polysilicon is processed to form TFTs. Optionally, a glue layer may be inserted between the shield layer and the transparent plate and/or the shield elements may be encapsulated within a barrier layer prior to the deposition of the polysilicon. Another option of the present invention is to omit the conventional black matrix, allowing the shielding elements to take its place. A process for manufacturing the display is also disclosed.

### FIELD OF THE INVENTION

The invention relates in general to an optical element such as a LCD display, and more particularly to an opaque shielding layer for shielding integrated circuit components of the optical element.

### BACKGROUND OF THE INVENTION

FIG. 1 is a schematic plan view of a LCD (liquid crystal display) 1 having an array of light valves 2, and row and column addressing lines 3. FIG. 1 shows a 5×5 array of light valves, but typically the LCD display 1 comprises up to 1,200×1,000 light valves 2 and associated addressing lines 3. The valves are shown as square arrays but it is to be understood that other shapes, such as rectangles, can be used. In this example, the LCD display is a transmissive type arranged to selectively allow light through the array depending upon the state of each light valve.

FIG. 2 is a schematic cross-sectional view of the LCD display 1. This display optionally comprises upper and lower outer substrates 10 of a suitable transparent material, such as glass or, for the plate on which the TFT is formed, preferably quartz, at a separation of about 1 to 5 mm. The space between the quartz plates 10 is sealed such as by an epoxy sealant (not shown) and filled with a liquid crystal layer 20, suitably a ferroelectric material or a twisted nematic material. Driving circuitry is carried by the plates 10. One of the plates 10 carries a large transparent sheet electrode 31 such as indium tin oxide (ITO) that may be coupled to a reference potential such as ground. The other quartz plate 10 carries a driving circuitry layer 30, including a regular array of smaller transparent sheet conductors 2, that define the locations of the pixels of the display, each being connected to a TFT 4 (connections not shown) which is accessed through the row and column addressing lines 3.

In use, a TFT is selectively activated by addressing the row and column addressing lines 3 either from an external circuit or from on-chip control circuitry, in order to change the light transmission properties of the liquid crystal layer 20 in that region, thus forming a light valve corresponding to one pixel of an image.

FIG. 3 is a schematic sectional view of a preferred device structure that may be used in the driving circuitry layer 30. FIG. 3 illustrates two of the TFTs 4 shown in FIG. 2, aid this device structure is repeated many times throughout the circuitry layer 30.

Circuitry sub-structure 30 is shown in greater detail in FIG. 3. Typically, the first layer of the integrated circuitry layer is an active silicon layer 302. The active silicon layer 302 will generally include doped source and drain regions having a channel region between them. Further layers are provided over the active silicon layer 302 in order to form a thin film transistor device as will be apparent to one skilled in the art.

Briefly, the device structure includes the active silicon layer 302, gate oxide 303, gate material 304, insulating layers 305, 306, and 307, surface protection such as oxide layer 309, a black matrix layer 301, positioned to lie between and slightly overlap the pixel areas defined by 2 (see FIG. 2), and conducting layers including a metal 1 (M1) layer 310, and a transparent metal 3 (M3) layer 311 such as indium tin oxide. Layers 311, 310 are connected to 302 and 304 (by connections that are not shown). Alternatively, the black matrix may be positioned on the opposite glass plate (27 in FIG. 2). However, the device structure, per se, is not particularly relevant to the present invention and need not be described in further detail here.

A problem arises in that some portions of the integrated circuitry layer 30, and in particular the active silicon layer 302, are exposed to high intensity visible light radiation (and near ultraviolet radiation) when the optical element is in use, which results in unwanted photoconductivity effects. Hence, it would be advantageous to substantially reduce light intensity in the device structure, especially at the active silicon layer 302.

One application of LCDs for which the above noted photoconductivity effects can be particularly troublesome is to digital projectors. The operation of digital projectors requires that a very high energy lamp be used. The light is split into three and passed through three displays, one for each color. The three beams are then recombined. Hence there is no color pigmentation included on the LCD itself. The very high energy lamps used in this kind of projector affect the actual transistor performance because of the photoconductivity effects discussed earlier.

Furthermore, the TFT's used in digital projection LCDs are of polysilicon rather than amorphous silicon. The former have much higher mobility and lower leakage currents than the latter. Polysilicon TFTs are manufactured on quartz substrates so that the devices can be processed at temperatures in excess of 1,000EC, compared to amorphous silicon devices which are processed on glass sheets with a maximum processing temperature of about 600EC. This allows the control circuitry to be located on chip as well as allowing much smaller transistors to be fabricated with acceptable leakage.

This invention describes a scheme whereby adding a layer under the TFT's improves immunity to photoconductivity effects.

The black matrix 301 of FIG. 3, or 27 in FIG. 2, is used to block light from between adjacent pixels. In prior art devices it is located on the opposite plate, as shown above. To minimize light scattering across the gap between the plates, it needs to be wider than this gap but this, in turn, reduces the aperture ratio. This is much more of a problem for displays used in digital projectors as the pixel size (15 to 30 microns) is much smaller than amorphous displays (100 to 200 microns).

A routine search of the prior art was performed with the following references of interest being found:

Kwon et al. in U.S. Pat. Nos. 5,866,919 and 5,926,702, show LCDs based on amorphous silicon TFTs, with black matrix layers made of opaque resin located over the active devices on the far side away from the lower plate. U.S. Pat. No. 5,337,068 (Stewart et al.) shows a back-lighted LCD. In U.S. Pat. No. 5,990,999 Yeo shows an LCD with a protective layer. U.S. Pat. No. 6,057,586 (Bawolek et al.) shows a light shielding layer for a light sensor, while U.S. Pat. No. 6,057,896 (Rho et al. ) shows a related process. Hsieh et al. (U.S. Pat. No. 5,666,177) show a LCD color display in which there is a black matrix in contact with the lower transparent plate. However, their display contains no TFTs so their black matrix is not a refractory material nor is a lower plate of quartz needed.

### SUMMARY OF THE INVENTION

It has been an object of the present invention to provide an optical element wherein components of an included circuitry layer have reduced exposure to strong light intensities during use.

A further object has been that said circuitry layer includes an active silicon layer, and a shielding layer that is between an insulating substrate layer and the active silicon layer.

Another object has been that said optical element be suitable for use in a LCD.

Still another object has been that said LCD be suitable for use as part of a digital projector.

An additional object has been to provide a process for manufacturing said LCD.

These objects have been achieved by inserting an opaque optical shielding element between the TFT active layer and the lower transparent plate of the LCD. By making the lower transparent plate out of quartz, or similar material, and the shielding element from a refractory material such as tungsten, the TFT active layer can be made of polysilicon (as opposed to amorphous silicon) since the plate and shield element will not be affected by the high temperatures, in excess of 1,000 EC, to which they will be exposed when the polysilicon is processed to form TFTs. Optionally, a glue layer may be inserted between the shield layer and the transparent plate and/or the shield elements may be encapsulated within a barrier layer prior to the deposition of the polysilicon. Another option of the present invention is to omit the conventional black matrix, allowing the shielding elements to take its place.

### BRIEF DESCRIPTION OF THE DRAWINGS

FIG. 1 is a schematic plan view of an optical element.

FIG. 2 is a schematic sectional view of the optical element of FIG. 1.

FIG. 3 is an more detailed schematic sectional view of part of FIG. 2.

FIG. 4 is a schematic sectional view of a part of FIG. 3, including a thin film transistor below which is an opaque optical shielding element.

FIG. 5 is a closeup view of the shielding element seen in FIG. 4.

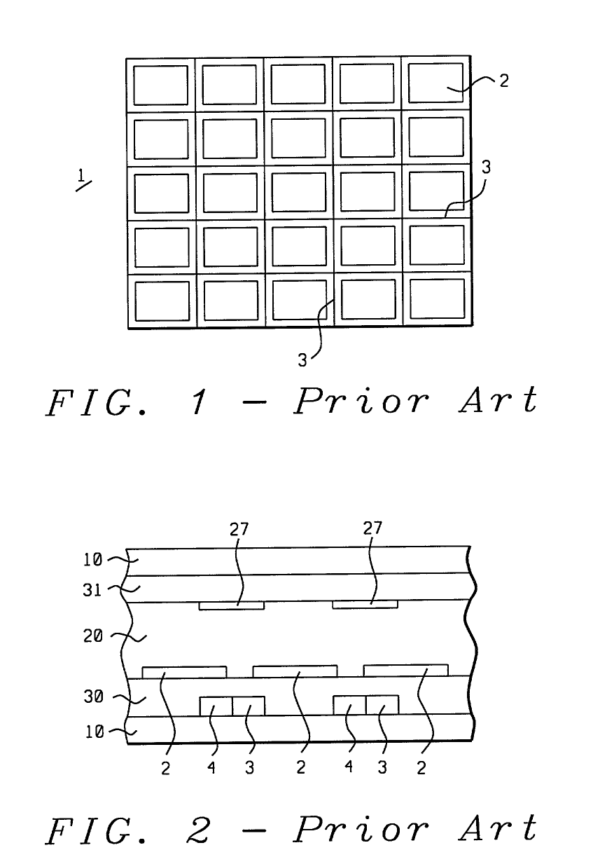

### DESCRIPTION OF THE PREFERRED EMBODIMENTS

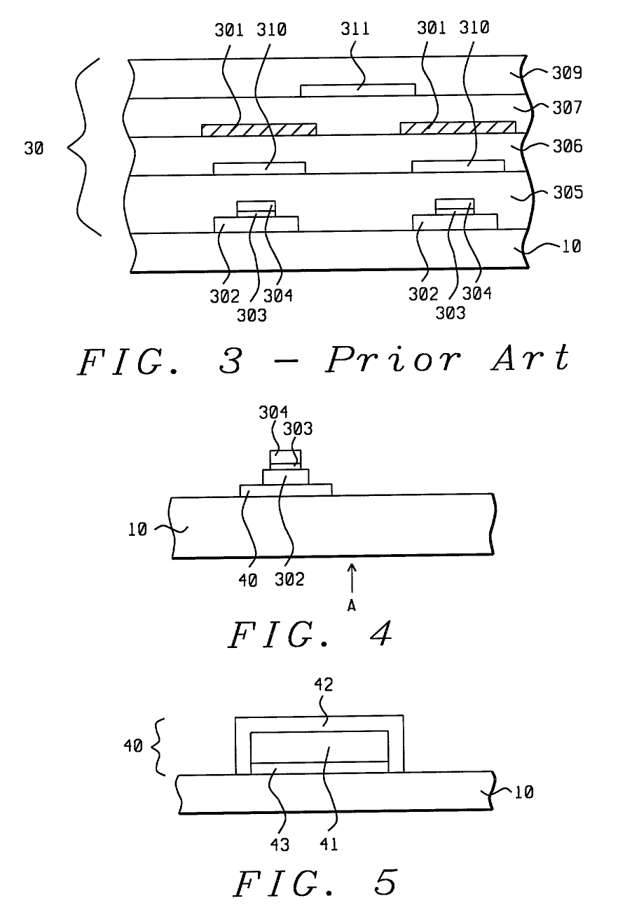

Referring now to FIG. 4, we show there a more detailed view of TFT 4, first seen in FIG. 2 and again, further expanded into its component parts, in FIG. 3. In a key departure from the prior art, shielding layer 40 is provided between the plate 10 and the circuitry layer 30. By providing the shielding layer 40 on an interior surface of plate 10, good optical register with components of the circuitry layer 30 is assured. Plate 10 may lie toward a main light receiving direction, illustrated by arrow A in FIG. 4.

It has been difficult to select appropriate materials for the opaque shielding layer 40. It is desired that the shielding layer 40 have good opacity to visible light radiation, as well as to near ultraviolet radiation. Also, the shielding layer should exhibit good planarity and readily receive the device structure of the circuitry layer 30. Its thickness should be between about 0.05 and 1 microns. Further, the initial processing steps in the manufacture of the integrated circuits of the circuitry layer 30 may involve relatively high temperatures. Hence, it is desired that the shielding layer 40 be stable at temperatures in the region of about 600° C. to above 1000° C. Additionally, the shielding layer must not degrade the performance of the circuitry layer that is placed on it.

Although metals in general provide the necessary opacity for proper functioning of shielding layer 40, and are easy to deposit, most metals tend to melt during the subsequent high temperature process steps and have been found unsatisfactory in practice. Further still, it is desired that the opaque shielding layer 40 should not contaminate or interfere with the circuitry layer 30, particularly the active silicon layer 302, either during the high temperature processing steps or subsequently.

It has been found that materials suitable for use in the shielding layer 40 include: (a) thermally deposited silicon nitride (b) layers of silicon oxide and silicon nitride, or (c) a refractory metal encapsulated in a suitable barrier layer.

Referring to FIG. 5, in one preferred embodiment the shielding layer 40 comprises a refractory metal layer 41 encapsulated in barrier layer 42. The refractory metal layer 41 suitably comprises tungsten but other metals such as cobalt, titanium, etc. could also have been used or the silicide of a metal such as tungsten could have been used. Optionally, an adhesive layer 43 may also be used. Our preferred material for this has been a titanium/titanium nitride laminate but other similar materials could also have been used. Barrier layer 42 can be a material such as tungsten silicide, tungsten nitride, or titanium nitride or one of these materials could be given an additional cap of deposited silicon oxide, nitride, or oxynitride.

In one preferred fabrication method, the shielding layer 40 is first deposited and patterned on the quartz plate 10, and the active silicon layer 302 of the circuitry layer 30 is formed on the shielding layer. Alternatively, both layers may be patterned simultaneously. This is followed by the formation of wiring layer 310. In all cases, the shielding layer 40 forms a regular array of transparent portions divided by non-transparent shielded portions. Further, the non-transparent portions are aligned in good optical register with the sections of the circuitry layer 30 that it is desired to shield from optical radiation. In particular, excellent optical alignment with the active silicon layer 302 is possible.

The shielding layer 40 may comprise a reflective material that scatters light back toward the light source, or it may comprise a non-reflective light absorbent material. Where a non-reflective material is used it is desirable that this material be a relatively good thermal conductor, and that the shielding layer 40 be thermally coupled to a heat sink. Another option is to allow the shielding elements to provide the function of the black matrix.

Three particular examples will now be described to illustrate the preferred embodiments of the present invention.

Silicon nitride can be deposited on an underlying substrate using either Plasma Enhanced Chemical Vapor Deposition (PECVD) or a Low Pressure Chemical Vapor Deposition (LPCVD) process. Typically LPCVD silicon nitride is deposited using either a DCS/NH₃ or SiH₄/NH₃ gas source at between 700-850 EC. A typical PECVD silicon nitride is deposited using a combination of SiH₄/N₂O/NH₃ gas sources at between 300-400 EC.

Silicon dioxide (SiO₂) can either be grown or deposited on the underlying substrate. Silicon dioxide can be thermally grown on a silicon substrate using either a dry oxidation (O₂ only) or a wet oxidation (H₂O₂+O₂) at temperatures typically between 800-1100 EC. In the case of deposited oxides, techniques such as PECVD, LPCVD or Atmospheric Pressure Chemical Vapor Deposition (APCVD) can be used. PECVD would typically use a SiH₄ gas source at temperatures between 300-400 EC. LPCVD uses TEOS/O₂ at temperatures of 600-800 EC, or SiH₄/O₂ at lower temperatures. APCVD would use a SiH₄/O₂ gas source at temperatures between 350-500 EC.

Tungsten silicide is typically deposited by Chemical Vapor Deposition using WF₆ and either SiH₄ or DCS. Titanium (Ti) and Titanium Nitride (TiN) films are typically deposited by Physical Vapor Deposition (PVD) from a suitable metal target in ultra high vacuum.

While the invention has been particularly shown and described with reference to the preferred embodiments thereof, it will be understood by those skilled in the art that various changes in form and details may be made without departing from the spirit and scope of the invention.

What is claimed is:

1. An optical element consisting of:
a transparent insulating substrate;
a circuitry layer on the insulating substrate; and
an opaque optical shielding layer disposed to lie between the insulating substrate layer and the circuitry layer.

2. The optical element of claim 1, wherein the circuitry layer includes an active polysilicon layer, and the shielding layer is between the insulating substrate and the active polysilicon layer.

3. The optical element of claim 1 wherein the shielding layer comprises a material that is unaffected by exposure to temperatures up to 1,100 EC

4. The optical element of claim 2 wherein the shielding layer comprises a material that is unaffected by exposure to temperatures up to 1,100 EC

5. The optical element of claim 1 wherein the optical element is part of a liquid crystal display and the opaque shielding layer also functions as a black matrix for said display.

6. A liquid crystal display, comprising:
a first transparent plate having an upper surface;
on said upper surface, an array of opaque optical shielding areas;
on each of said shielding areas, a thin film transistor having a source, a drain, an active region, a gate oxide layer, and a gate pedestal over the gate oxide;
a first dielectric layer that fully covers said thin film transistor, including the gate pedestal;
on the first dielectric layer a wiring layer;
a second dielectric layer that covers the wiring layer;
on the second dielectric layer, additional wiring and dielectric layers, including a topmost dielectric layer;
on the topmost dielectric layer, an array of transparent conductive pixel control elements;
a passivation layer on the topmost dielectric layer and pixel elements;
a second transparent plate having a lower surface;
on said lower surface, a layer of transparent conductive material; and
the transparent plates being aligned to face, and lie parallel to, one another, with a space between them that is filled with liquid crystal material.

7. The liquid crystal display described in claim 6 wherein the opaque shielding layer is selected from the group consisting of a thermally deposited silicon nitride layer, a silicon oxide silicon nitride laminate, and a refractory metal encapsulated in a barrier layer.

8. The liquid crystal display described in claim 6 wherein the opaque shielding layer has a thickness between about 0.05 and 1 microns.

9. The liquid crystal display described in claim 6 wherein said shielding layer further comprise a refractory metal or a metal silicide and, between said first transparent plate and shielding layer, there is, under the shielding layer, a glue layer selected from the group consisting of titanium and titanium nitride.

10. The liquid crystal display described in claim 6 further comprising, between the shielding layer and the thin film transistor, a barrier layer, selected from the group consisting of tungsten nitride, titanium nitride, a laminate of tungsten nitride and silicon oxide, a laminate of tungsten nitride and silicon nitride, a laminate of tungsten nitride and silicon oxynitride, a laminate of titanium nitride and silicon nitride, a laminate of titanium nitride and silicon oxide, and a laminate of titanium nitride and silicon oxynitride.

11. The liquid crystal display described in claim 6 wherein no black matrix element is present and said shielding element also serves to block out light between pixels.

12. The liquid crystal display described in claim 6 wherein the thin film transistor is polysilicon.

13. The liquid crystal display described in claim 6 wherein said display forms part of a digital projection system.

14. The liquid crystal display described in claim 6 wherein the shielding element is a reflective material.

15. The liquid crystal display described in claim 6 wherein the shielding element is a non-reflective material as well as a good thermal conductor and is thermally coupled to a heat sink.

16. A process for manufacturing a liquid crystal display, comprising the sequential steps of:
providing a first transparent plate having an upper surface;
depositing on said upper surface an opaque optical shielding layer and then patterning and etching said shielding layer to form individual shield areas;
forming, on each of said shielding areas, a thin film transistor having a source, a drain, an active region, a gate oxide layer, and a gate pedestal over the gate oxide;
depositing a first dielectric layer to fully cover said thin film transistor, including the gate pedestal;
on the first dielectric layer depositing a metal layer which is then patterned and etched to form a wiring layer;
depositing a second dielectric layer that covers said wiring layer;
on the second dielectric layer, depositing a black matrix layer then patterning and etching said layer to form a black matrix element that is positioned to overlie and overlap the thin film transistor;
on the black matrix and the second dielectric layer, depositing a third dielectric layer;
on the third dielectric layer, depositing a first layer of transparent conductive material and then patterning and etching said first transparent conductive layer to form a pixel control element;
depositing a passivation layer on the third dielectric layer and on said pixel element;
providing a second transparent plate having a lower surface;
on said lower surface, depositing a second layer of transparent conductive material;
aligning the transparent plates to face, and lie parallel to, one another, thereby creating a space between them; and
introducing, and then confining, liquid crystal material in said space.

17. The process described in claim 16 wherein the first transparent plate is selected from the group consisting of quartz, glass, and sapphire.

18. The process described in claim 16 wherein the opaque shielding layer is selected from the group consisting of tungsten, titanium, tungsten silicide, titanium silicide, and cobalt silicide.

19 The process described in claim 16 wherein the opaque shielding layer is deposited to a thickness between about 0.05 and 1 microns.

20. The process described in claim 16 wherein said shielding layer further comprise a refractory metal or a metal silicide and, between said first transparent plate and shielding layer, depositing, under the shielding layer, a glue layer selected from the group consisting of titanium and titanium nitride.

21. The process described in claim 16 further comprising depositing, between the shielding layer and the thin film transistor, a barrier layer, selected from the group consisting of tungsten nitride, titanium nitride, a laminate of tungsten nitride and silicon oxide, a laminate of tungsten nitride and silicon nitride, a laminate of tungsten nitride and silicon oxynitride, a laminate of titanium nitride and silicon nitride, a laminate of titanium nitride and silicon oxide, and a laminate of titanium nitride and silicon oxynitride.

22. The process described in claim 16 wherein the step of depositing a black matrix layer then patterning and etching said layer to form a black matrix element, is omitted, whereby said shielding layer will serve as a black matrix.

23. The process described in claim 16 wherein the thin film transistor is polysilicon.
